(19) United States
(12) Patent Application Publication
(10) Pub. No.: US 2026/0064985 A1
(43) Pub. Date: Mar. 5, 2026

(54) GENERATION DEVICE, GENERATION METHOD, AND GENERATION RECORDING MEDIUM

(71) Applicant: Hitachi, Ltd., Tokyo (JP)

(72) Inventors: Yohei KAWAGUCHI, Tokyo (JP); Tomoya NISHIDA, Tokyo (JP)

(21) Appl. No.: 19/281,132

(22) Filed: Jul. 25, 2025

(30) Foreign Application Priority Data
Aug. 27, 2024 (JP) 2024-145953

(51) Int. Cl. G06F 40/40; G01M 99/00; G06F 40/166

(52) U.S. Cl. CPC G06F 40/40; G01M 99/005; G06F 40/166

(57) ABSTRACT

A generation device includes: a storage unit that stores a set of training data sets each being a combination of a sound signal indicating a state and an explanatory sentence explaining the state in a character string; a signal encoding unit configured to encode, based on a first learning parameter, the sound signal to generate a sound feature vector; a language encoding unit configured to encode, based on a second learning parameter, the explanatory sentence to generate a language feature vector; a language decoding unit configured to decode, based on a third learning parameter, the sound feature vector into a text indicating the state; and an updating unit configured to update the first and second learning parameters by contrast learning using a combination of sound feature and language feature vectors, and updates the third learning parameter based on a difference between the explanatory sentence and the decoded text.

### CLAIM OF PRIORITY

The present application claims priority from Japanese patent application No. 2024-145953 filed on Aug. 27, 2024, the content of which is hereby incorporated by reference into this application.

### BACKGROUND OF THE INVENTION

### 1. Field of the Invention

The present invention relates to a generation device, a generation method, and a generation program for generating a character string.

### 2. Description of the Related Art

It is important to generate, from signals obtained under two different conditions, a character string explaining in natural language what has changed between the signals due to a change in the condition. For example, an abnormality of a facility or a machine or a sign thereof is automatically detected from an operation sound. However, in the presentation of only the presence or absence of the abnormality or the sign, it is not possible to know what to focus on in the subsequent manual detailed inspection, and man-hours are required.

On the other hand, if the difference between the sound in the normal state measured in the past and the sound determined as the current abnormality can be automatically presented in natural language in an easy-to-understand manner, it serves as a clue for detailed inspection by an inspector user, and the man-hours are further reduced.

A character string generation method for explaining, in natural language, what has changed between two optical images is disclosed in Dong Huk Park, Trevor Darrell, and Anna Rohrbach, “Robust Change Captioning,” in arxiv, 17 Apr. 2019. Here is a citation from the document, “We present a novel Dual Dynamic Attention Model (DUDA) to perform robust Change Captioning. Our model learns to distinguish distractors from semantic changes, localize the changes via Dual Attention over “before” and “after” images, and accurately describe them in natural language via Dynamic Speaker, by adaptively focusing on the necessary visual inputs (e.g. “before” or “after” image)”.

Dong Huk Park, Trevor Darrell, and Anna Rohrbach, “Robust Change Captioning,” in arxiv, 17 Apr. 2019.

### SUMMARY OF THE INVENTION

In Dong Huk Park, Trevor Darrell, and Anna Rohrbach, “Robust Change Captioning,” in arxiv, 17 Apr. 2019, an optical image is a target, and thus, a local change in a limited pixel region such as an object movement is a main detection target. Therefore, what is the change to be focused on is relatively clear from the image. Meanwhile, training data is created by a human called an annotator manually adding explanatory character strings that are considered to be correct to two images, one before and one after the change. Since the change to be focused on is relatively clear in the case of an optical image as described above, the annotator can add an appropriate explanatory character string. Therefore, appropriate training data can be created, and a generative model of character string generation can be trained based on the training data, so that accurate character string generation can be realized.

However, in a case where a general signal is targeted, in particular, a sound or vibration of equipment, a machine, or the like, a component thereof is not locally limited in terms of a time frequency, and a change thereof, such as a magnitude of a volume, a pitch, new generation or extinction of a sound source, or the like, is also over the entire signal component. Since there are numerous changes between the signals before and after the change, it is not clear what is the change to be focused on. Therefore, unless the annotator knows what to focus on among the myriad of changes, a desired explanatory sentence cannot be added. Therefore, appropriate training data cannot be created, and even if a generative model of character string generation is trained based on the training data, accurate character string generation cannot be realized.

An object of the present invention is to learn to enable explanation, in a natural language, of what has changed between signals obtained under two different conditions due to the change in the condition from the signals. In addition, an object of the present invention is to explain, in a natural language, what has changed between signals obtained under two different conditions due to the change in the condition from the signals.

A generation device according to an aspect of the invention includes: a storage unit that stores a set of training data sets each being a combination of a sound signal indicating a state and an explanatory sentence explaining the state in a character string; a signal encoding unit configured to encode the sound signal based on a first learning parameter to generate a sound feature vector; a language encoding unit configured to encode the explanatory sentence based on a second learning parameter to generate a language feature vector; a language decoding unit configured to decode the sound feature vector into a text indicating the state based on a third learning parameter; and an updating unit configured to update the first learning parameter and the second learning parameter by contrast learning using a combination of a sound feature vector generated by the signal encoding unit and a language feature vector generated by the language encoding unit, and updates the third learning parameter based on a difference between the explanatory sentence and a text indicating the state decoded by the language decoding unit.

According to the representative aspects of the present invention, it is possible to improve the accuracy of an explanation of the basis in a case where an abnormality of the input sound is detected. Issues, configurations, and effects other than those described above will be clarified by the following description of embodiments.

### BRIEF DESCRIPTION OF THE DRAWINGS

FIG. 1 is a block diagram illustrating a hardware configuration example of a generation device;

FIG. 2 is a block diagram illustrating a functional configuration example of the generation device according to a first embodiment;

FIG. 3 is a block diagram illustrating a functional configuration example of a learning unit according to the first embodiment;

FIG. 4 is a flowchart illustrating an example of a learning processing procedure of the learning unit according to the first embodiment;

FIG. 5 is a block diagram illustrating a functional configuration example of a generation unit according to the first embodiment;

FIG. 6 is a flowchart illustrating an example of a generation processing procedure of the generation unit according to the first embodiment;

FIG. 7 is a block diagram illustrating a functional configuration example of a learning unit according to a second embodiment;

FIG. 8 is a flowchart illustrating an example of a learning processing procedure of the learning unit according to the second embodiment;

FIG. 9 is a block diagram illustrating a functional configuration example of a generation unit according to the second embodiment;

FIG. 10 is a flowchart illustrating an example of a generation processing procedure of the generation unit according to the second embodiment;

FIG. 11 is a block diagram illustrating a functional configuration example of a learning unit according to a third embodiment;

FIG. 12 is a flowchart illustrating an example of a learning processing procedure of the learning unit according to the third embodiment;

FIG. 13 is a block diagram illustrating a functional configuration example of a generation unit according to the third embodiment; and

FIG. 14 is a flowchart illustrating an example of a generation processing procedure of the generation unit according to the third embodiment.

### DESCRIPTION OF THE PREFERRED EMBODIMENTS

### First Embodiment

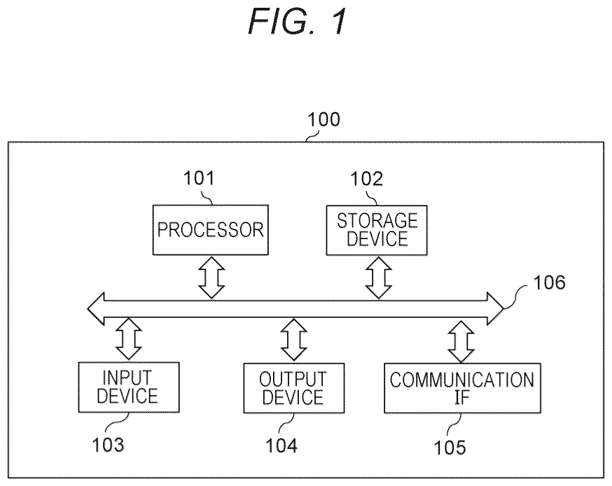

### <FIG. 1 Hardware Configuration Example of Generation Device>

FIG. 1 is a block diagram illustrating a hardware configuration example of a generation device. A generation device 100 includes a processor 101, a storage device 102, an input device 103, an output device 104, and a communication interface (communication IF) 105. The processor 101, the storage device 102, the input device 103, the output device 104, and the communication IF 105 are connected by a bus 106. The processor 101 controls the generation device 100. The storage device 102 serves as a work area of the processor 101. The storage device 102 is a non-transitory or transitory recording medium that stores various programs and data. Examples of the storage device 102 include, for example, a read only memory (ROM), a random access memory (RAM), a hard disk drive (HDD), and a flash memory. The input device 103 receives data. Examples of the input device 103 include, for example, a keyboard, a mouse, a touch panel, a numeric keypad, a scanner, a microphone, and a sensor. The output device 104 outputs data. Examples of the output device 104 include a display, a printer, and a speaker. The communication IF 105 is connected to a network and transmits and receives data.

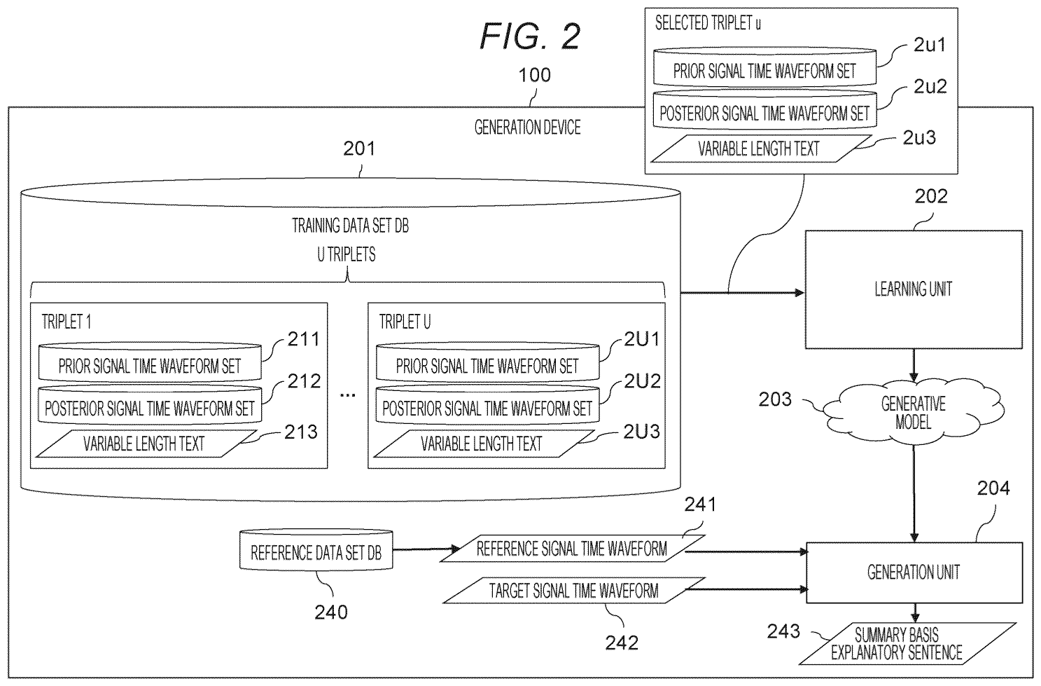

### <FIG. 2 Functional Configuration Example of Generation Device 100>

FIG. 2 is a block diagram illustrating a functional configuration example of the generation device 100 according to a first embodiment. The generation device 100 includes a training data set DB 201, a learning unit 202, a generative model 203, and a generation unit 204. Specifically, the training data set DB 201 is stored in, for example, the storage device 102 illustrated in FIG. 1 or another computer communicable with the generation device 100. Specifically, the learning unit 202, the generative model 203, and the generation unit 204 are realized, for example, by causing the processor 101 to execute a program stored in the storage device 102 illustrated in FIG. 1.

The training data set DB 201 is a database that stores one or more training data sets. The training data set is a combination of training data and correct data. The training data set DB 201 includes, as a training data set, a set of triplets u {Triplet 1, . . . , Triplet u, . . . , Triplet U}, each of the triplets including a prior signal time waveform set 2u1, a posterior signal time waveform set 2u2, and an explanatory sentence 2u3.

The prior signal time waveform set 2u1 is a set of prior signal time waveforms. The prior signal time waveform is training data indicating a time waveform of a prior signal. The prior signal is a signal under a condition before a change of a certain state, for example, a steady sound, a periodic sound, or an aperiodic sound of a device to be inspected. In the case of sound, the temporal waveform is a time waveform having a sound pressure value at each time as an element.

The posterior signal time waveform set 2u2 is a set of posterior signal time waveforms. The posterior signal time waveform is training data indicating a time waveform of the posterior signal. The posterior signal is a signal under a condition after a change of a certain state, for example, an abnormal sound of a device to be inspected that has changed from a steady sound in a state before the change.

When the prior signal time waveform and the posterior signal time waveform are not distinguished, they are referred to as signal time waveforms.

The explanatory sentence 2u3 is a variable length text including an onomatopoeia representing a change between the prior signal time waveform and the posterior signal time waveform.

The case of the explanatory sentence representing the change from the normal state to the abnormal state of the bearing of the rotating body is as follows. The character strings enclosed in double quotation marks are onomatopoeias added by an annotator.

“The sound “Boh” changed to the sound “Woo”, and the pitch of the sound became high.” “The sound “Win win” has disappeared.” “The pitch of the “Boon” sound and the “Shaa” sound increased, and the volume increased.”

Here, by instructing the annotator to focus on changes and create an explanatory sentence expressing the change, and using the explanatory sentence as correct data for the generative model 203, the generative model 203 can explain how the steady sound differs from the sound determined to be abnormal at that time.

The provision of the onomatopoeia by the annotator is extremely important for providing information that is a clue to detailed inspection by an inspector. This is because, even if only the posterior signal time waveform is given to the annotator and make the annotator answer to questions such as “What sound?” or “What kind of sound?” is given, only an answer including information independent of a change, such as “bearing sound” can be obtained.

In addition, there is a problem that it is not possible to express in detail what kind of sound has been changed and how the sound has been changed only by the explanation using a natural sentence that does not include an onomatopoeia. That is, without expression with an onomatopoeia, not only that the generative model 203 cannot express the sound in detail, but also an annotator cannot explain well so that a training data set used for learning of the generative model 203 cannot be created.

Therefore, by creating an explanatory sentence including an onomatopoeia in annotation, the annotator can express in detail what sound has changed and how. The generative model 203 capable of expressing the change in detail can be realized using the generated explanatory sentence.

It is also possible to cause an annotator to answer a classification of the sound (e.g., “bearing sound”) rather than an onomatopoeia, but an expression tends to increase the emerging vocabulary as the number of use scenes increases, while the increased vocabulary is not used in different scenes, so it is difficult to obtain a general-purpose model across scenes, which is disadvantageous. Therefore, focusing on the fact that onomatopoeias can be used generally across scenes, it is possible to obtain the generative model 203 that is of general-purpose across scenes by creating an explanatory sentence including an onomatopoeia by an annotation.

The learning unit 202 randomly selects a triplet u from a set {Triplet 1, . . . , Triplet u, . . . , Triplet U} including U triplets. As described above, the triplet u includes the prior signal time waveform set 2u1, the posterior signal time waveform set 2u2, and the explanatory sentence 2u3. Further, the learning unit 202 randomly selects one element from the prior signal time waveform set 2u1 among the triplet to set it as a prior signal time waveform 301, randomly selects one element from the posterior signal time waveform set 2u2 to set it as a posterior signal time waveform 302, sets a combination of the prior signal time waveform 301 and the posterior signal time waveform 302 as an explanatory variable, and sets the explanatory sentence 2u3 as an explanatory sentence 303 that is an objective variable.

The learning unit 202 performs learning of the generative model 203 using the triplet u. Specifically, for example, the learning unit 202 calculates a value of the loss function based on the difference between output data output as a result of inputting the set explanatory variable to the generative model 203 and the explanatory sentence 303, and updates the learning parameter of the generative model 203 such that the value of the loss function is minimized.

The generative model 203 is a language model that outputs an explanatory sentence when a signal time waveform is input. Learning of the generative model 203 is performed by the learning unit 202, and the generation unit 204 generates a summary basis explanatory sentence 243.

The generation unit 204 uses the generative model 203, and inputs the reference signal time waveform 241 and the target signal time waveform 242 to the generative model 203 to output the summary basis explanatory sentence 243. The reference signal time waveform 241 is a time waveform of a reference sound signal (hereinafter, a reference signal) to be a reference for a device to be inspected that is an abnormality detection target. The reference signal time waveform 241 may be a prior signal time waveform in a prior signal time waveform set 211, or may be a prior signal time waveform different from the prior signal time waveform in the prior signal time waveform set 211.

The target signal time waveform 242 is a time waveform of a sound signal (hereinafter, a target signal) emitted by the device to be inspected that is an abnormality detection target. The target signal time waveform 242 may be a posterior signal time waveform in a posterior signal time waveform set 212, or may be a posterior signal time waveform different from the posterior signal time waveform in the posterior signal time waveform set 212.

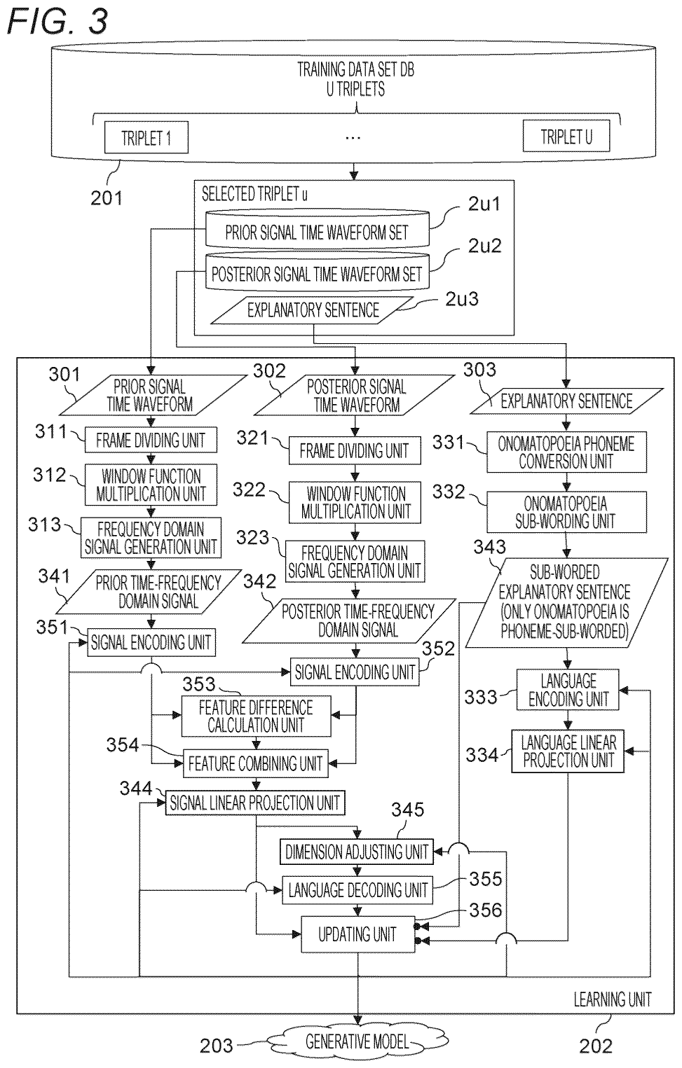

### <FIG. 3 Functional Configuration Example of Learning Unit 202>

FIG. 3 is a block diagram illustrating a functional configuration example of the learning unit 202 according to the first embodiment. The learning unit 202 includes frame dividing units 311 and 312, window function multiplication units 321 and 322, frequency domain signal generation units 313 and 323, signal encoding units 351 and 352, a feature difference calculation unit 353, a feature combining unit 354, a language decoding unit 355, an onomatopoeia phoneme conversion unit 331, an onomatopoeia sub-wording unit 332, and an updating unit 356.

Furthermore, the learning unit 202 includes a language encoding unit 333, a language linear projection unit 334, a signal linear projection unit 344, and a dimension adjusting unit 345.

The frame dividing units 311 and 312 divide the signal time waveform into waveforms for frames. Each of the signal time waveforms obtained by the division is referred to as a frame division signal.

The window function multiplication units 321 and 322 perform window function multiplication on the frame division signals to convert each of the frame division signals into a window function multiplication signal.

The frequency domain signal generation units 313 and 323 perform short-time Fourier transform on each of the window function multiplication signals to convert the signals into time-frequency domain signals. The frequency domain signal generation units 313 and 323 can also use a frequency conversion method such as constant Q conversion (CQT) instead of the short-time Fourier transform.

The signal encoding units 351 and 352 are neural networks that calculate a feature vector from the frequency domain signal based on the learning parameter of the signal encoding units 351 and 352. The signal encoding units 351 and 352 are each typically an encoder of a neural network in which a plurality of convolution layers, an activation function, and a pooling layer are stacked and a skip connection is interposed therebetween. Furthermore, the signal encoding units 351 and 352 may be recurrent neural networks having layers such as a known Transformer model, Long-Short-Term-Memory (LSTM), a bidirectional LSTM, a Gated recurrent unit (GRU), and a bidirectional GRU.

The feature difference calculation unit 353 calculates a difference vector that is a difference between the feature vector from the signal encoding unit 351 and the feature vector from the signal encoding unit 352. The difference vector is a feature in which a change is emphasized, and the generative model 203 that generates an explanatory sentence in which a change is emphasized can be generated by learning using the feature.

The feature combining unit 354 combines the feature vector from the signal encoding unit 351, the feature vector from the signal encoding unit 352, and the difference vector to generate a combined vector.

The signal linear projection unit 344 is a neural network that linearly projects the combined vector from the feature combining unit 354 to generate a signal feature vector of the dimension number N and output the signal feature vector to the dimension adjusting unit 345. This neural network is, for example, a fully connected layer or a combination of a fully connected layer and a suitable activation nonlinear function such as ReLU. Note that the signal linear projection unit 344 may directly output the signal feature vector of the dimension number N to the updating unit 356 instead of the dimension adjusting unit 345.

The dimension adjusting unit 345 is a neural network that adjusts the dimension of the input vector to the dimension of the text embedding vector of the dimension number P. Specifically, for example, the dimension adjusting unit 345 converts the signal feature vector of the dimension number N from the signal linear projection unit 344 into a text embedding vector of the dimension number P. In addition, the language feature vector of the dimension number M (#N) from the language linear projection unit 334 is converted into a text embedding vector of the dimension number P. In this manner, the dimension adjusting unit 345 converts a plurality of vectors of different dimension numbers into vectors of the same dimension number. This neural network is, for example, a fully connected layer or a combination of a fully connected layer and a suitable activation nonlinear function such as ReLU.

The onomatopoeia phoneme conversion unit 331 extracts a character string enclosed in double quotation marks from the explanatory sentence 303 as an onomatopoeia and converts the extracted onomatopoeia into a phoneme string to generate a text obtained by onomatopoeia phoneme conversion. For example, when the onomatopoeia is “Kankan”, the phoneme string is /k a N k a N/. In addition, when the onomatopoeia is “Katakatadoon”, the phoneme string is /ka t a k a t a d o: N/. Therefore, the example “The pitch of the “Boon” sound and the “Shaa” sound increased, and the volume increased.” of the explanatory sentence 303 is converted into “The pitch of the /b u: N/sound and the /sh a:/sound became high, and the volume became large”.

The onomatopoeia sub-wording unit 332 sub-words the text obtained by onomatopoeia phoneme conversion. Specifically, for example, the onomatopoeia sub-wording unit 332 outputs a partial character string cut out for each predetermined number of characters n (the number of grams) while shifting, by one character, the target range of the phoneme string of the onomatopoeia in the text obtained by onomatopoeia phoneme conversion.

For example, when the onomatopoeia is “Katakatadoon”, the original phoneme (/k a t a k a t a d o: N/) is converted into phoneme sub-words as follows (assuming n=4).
/k a t a /
/a t a k/
/t a k a/
/a k a t/
/k a t a/
/a t a d/
/t a d o:/
/a d o: N/

Hereinafter, n=4 characters in each line are treated as one word. As a result, the sub-worded explanatory sentence 343 in which only the onomatopoeia is phoneme-sub-worded is generated.

The effect of the onomatopoeia sub-wording will be described. The onomatopoeia has a sparse appearance frequency compared to normal words. For example, “Katakatadoon” rarely appears in other scenes. Therefore, if the onomatopoeia is directly input to a language model, similar onomatopoeias are distinguished as completely different words, and thus training data per word is insufficient, disabling training. The sub-wording has an effect of preventing insufficient training data by decomposing “Katakatadoon” into phoneme strings such as “kata” and “taka” that appear highly frequently.

The language encoding unit 333 calculates a language feature vector from the sub-worded explanatory sentence 343 based on the learning parameter of the language encoding unit 333. The language encoding unit 333 is typically an encoder of a neural network in which a plurality of convolution layers, an activation function, and a pooling layer are stacked and a skip connection is interposed therebetween. Furthermore, the language encoding unit 333 may be a recurrent neural network having layers such as a known Transformer model, Long-Short-Term-Memory (LSTM), a bidirectional LSTM, a Gated recurrent unit (GRU), and a bidirectional GRU.

The language linear projection unit 334 is a neural network that linearly projects the language feature vector from the language encoding unit 333 to generate a language feature vector of the dimension number M and output the language feature vector to the dimension adjusting unit 345. This neural network is, for example, a fully connected layer or a combination of a fully connected layer and a suitable activation nonlinear function such as ReLU. Note that the language linear projection unit 334 may directly output the language feature vector of the dimension number M to the updating unit 356 instead of the dimension adjusting unit 345.

The language decoding unit 355 uses a text embedding vector of a dimension number P from the dimension adjusting unit 345 originated from the signal linear projection unit 344 as an input, and generates a variable length text in which the phonemes of the onomatopoeia are converted to sub-words, similarly to the sub-worded explanatory sentence 343 to be described below. The language decoding unit 355 is, typically, a decoder of a known Transformer model, which is a type of neural network. Furthermore, the language decoding unit 355 may be a recurrent neural network having layers such as a Long-Short-Term-Memory (LSTM), a bidirectional LSTM, a Gated recurrent unit (GRU), and a bidirectional GRU.

The updating unit 356 performs learning processing of updating the learning parameter of the neural network.

Specifically, for example, the updating unit 356 compares the variable length text (however, in the variable length text, phonemes of the onomatopoeia are sub-worded similarly to the sub-worded explanatory sentence 343) generated by the language decoding unit 355 with the sub-worded explanatory sentence 343 generated by the onomatopoeia sub-wording unit 332, and calculates a cross entropy L of the following formula (1).

$$\begin{matrix}[ Mathematical formula 1 ] & \\ L = {\sum }_{k = 1}^{K \_ u} {\sum }_{i = 1}^{I \_ u} {\sum }_{t = 1}^{T} log [ p ( w ( t ) \vert w\_ 1 : t - 1 , X ) ] & ( 1 )\end{matrix}$$

Here, K u is the total number of elements belonging to the prior signal time waveform set 2u1, and k is a number uniquely identifying an element of the set. I_u is the total number of elements belonging to the posterior signal time waveform set 2u2, and i is a number uniquely identifying an element of the set. T is the number of words appearing in the sub-worded explanatory sentence 343. t is the number uniquely identifying the word. w(t) is a probability of correctly estimating the t-th word, and can be calculated by comparing the variable length text (however, in the variable length text, phonemes of the onomatopoeia are sub-worded similarly to the sub-worded explanatory sentence 343) generated by the language decoding unit 355 with the sub-worded explanatory sentence 343. w_1: t−1 represents a word sequence from t=1 to t=t−1. X is a combined vector. The optimization can be performed using, for example, a known optimization algorithm such as SGD, Momentum SGD, AdaGrad, RMSProp, AdaDelta, or Adam.

In addition, the updating unit 356 performs contrast learning, that is, calculates a contrast loss of a symmetric matrix configured by cosine similarity between the text embedding vector of the dimension number P from the dimension adjusting unit 345 originated from the signal linear projection unit 344 (which may be the signal feature vector of the dimension number N from the signal linear projection unit 344) and the text embedding vector of the dimension number P from the dimension adjusting unit 345 of the dimension number M based on the language linear projection unit 334 (which may be the language feature vector of the dimension number M from the language linear projection unit 334) based on the text embedding vectors.

The updating unit 356 uses the sum of the cross entropy L and the contrast loss as a loss function, and updates the learning parameter of each neural network such that the loss function is small.

Specifically, for example, the updating unit 356 updates the learning parameter of each neural network of the language decoding unit 355 and the dimension adjusting unit 345 such that the cross entropy L is small.

Furthermore, the updating unit 356 updates the learning parameter of each neural network in the signal encoding units 351 and 352, the language encoding unit 333, the signal linear projection unit 344, and the language linear projection unit 334 such that the contrast loss is small, that is, the diagonal elements of the symmetric matrix are large and the off diagonal elements are small.

Specifically, for example, in a P×P symmetric matrix including both the text embedding vectors, each element is the similarity between the text embedding vectors. The similarity is the Euclidean distance or cosine similarity of the text embedding vectors. The smaller the Euclidean distance is and the closer the cosine similarity to 1 is, the higher the similarity between the text embedding vectors is.

The updating unit 356 updates the learning parameter of each neural network in the signal encoding units 351 and 352, the language encoding unit 333, the signal linear projection unit 344, and the language linear projection unit 334 such that the similarity between the text embedding vectors indicated by the diagonal elements of the symmetric matrix is high and the similarity between the text embedding vectors indicated by the non-diagonal elements is low.

A combination of the neural networks (encoding models) of the signal encoding units 351 and 352, the language encoding unit 333, the signal linear projection unit 344, and the language linear projection unit 334 with the updated learning parameter and the neural networks (decoding models) of the language decoding unit 355 and the dimension adjusting unit 345 with the updated learning parameter serves as the generative model 203.

The signal linear projection unit 344 that is pre-trained as described above includes general knowledge regarding sound. Therefore, by using the signal linear projection unit 344, the data to be additionally learned can be greatly reduced, and the data to be additionally learned becomes unnecessary.

Similarly, the pre-trained language linear projection unit 334 also includes general knowledge regarding natural language. Therefore, by using the language linear projection unit 334, the data to be additionally learned can be greatly reduced, and the data to be additionally learned becomes unnecessary.

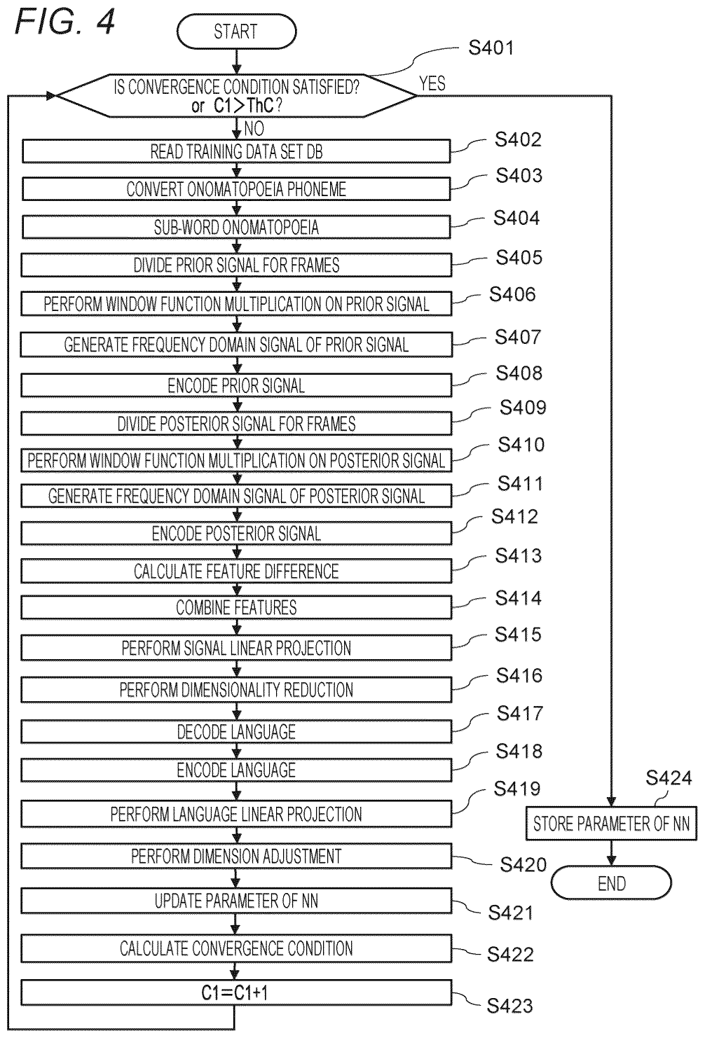

### <FIG. 4 Learning Processing Procedure of Learning Unit 202>

FIG. 4 is a flowchart illustrating an example of a learning processing procedure of the learning unit 202 according to the first embodiment.

### (Step S401)

The updating unit 356 determines whether the value of the loss function converges. Specifically, for example, the updating unit 356 determines whether the convergence condition is satisfied or whether the number of iterations C1 is larger than a threshold ThC. The convergence condition is, for example, a condition that the value of the convergence determination function is smaller than a predetermined threshold.

When the convergence condition is not satisfied and when the number of iterations C1 is not larger than the threshold ThC (step S401: No), the processing proceeds to step S402. When the convergence condition is satisfied or when the number of iterations C1 is larger than the threshold ThC (step S401: Yes), it is determined that the value of the loss function has converged, and the processing proceeds to step S424.

### (Step S402)

The learning unit 202 randomly selects a triplet u from the training data set DB 201. As described above, the triplet u includes the prior signal time waveform set 2u1, the posterior signal time waveform set 2u2, and the explanatory sentence 2u3. Further, the learning unit 202 randomly selects one element from 2u1 among the triplet to set it as a prior signal time waveform 301, randomly selects one element from 2u2 to set it as a posterior signal time waveform 302, sets a combination of the prior signal time waveform 301 and the posterior signal time waveform 302 as an explanatory variable, and sets the explanatory sentence 2u3 as an explanatory sentence 303 that is an objective variable.

### (Step S403)

The onomatopoeia phoneme conversion unit 331 extracts an onomatopoeia from the explanatory sentence 303 and converts the extracted onomatopoeia into a phoneme string to generate a text obtained by onomatopoeia phoneme conversion.

### (Step S404)

The onomatopoeia sub-wording unit 332 sub-words the text obtained by onomatopoeia phoneme conversion by the onomatopoeia phoneme conversion unit 331 to generate the sub-worded explanatory sentence 343.

### (Step S405)

The frame dividing unit 311 divides the prior signal time waveform into waveforms for frames. The frame division signals from the frame dividing unit 311 are referred to as prior frame division signals.

### (Step S406)

The window function multiplication unit 321 performs window function multiplication on the prior frame division signals to convert each of the prior frame division signals into a window function multiplication signal. This window function multiplication signal is referred to as a prior window function multiplication signal.

### (Step S407)

The frequency domain signal generation unit 313 performs short-time Fourier transform on each of the prior window function multiplication signals to convert the signals into time-frequency domain signals. The time-frequency domain signals are referred to as prior time-frequency domain signals.

### (Step S408)

The signal encoding unit 351 calculates a feature vector from the prior frequency domain signal based on the learning parameter of the signal encoding unit 351. This feature vector is referred to as a prior feature vector.

### (Step S409)

The frame dividing unit 312 divides the posterior signal time waveform into waveforms for frames. The frame division signals from the frame dividing unit 312 are referred to as posterior frame division signals.

### (Step S410)

The window function multiplication unit 322 performs window function multiplication on the posterior frame division signals to convert each of the posterior frame division signals into a window function multiplication signal. This window function multiplication signal is referred to as a posterior window function multiplication signal.

### (Step S411)

The frequency domain signal generation unit 323 performs short-time Fourier transform on each of the posterior window function multiplication signals to convert the signals into time-frequency domain signals. The time-frequency domain signals are referred to as posterior time-frequency domain signals.

### (Step S412)

The signal encoding unit 352 calculates a feature vector from the posterior frequency domain signal based on the learning parameter of the signal encoding unit 352. This feature vector is referred to as a posterior feature vector.

Note that steps S409 to S412 may be performed in parallel with steps S405 to S408.

(Step S413) The feature difference calculation unit 353 calculates a difference vector that is a difference between the prior feature vector and the posterior feature vector.

### (Step S414)

The feature combining unit 354 combines the prior feature vector, the posterior feature vector, and the difference vector to generate a combined vector.

### (Step S415)

The signal linear projection unit 344 linearly projects the combined vector generated in step S414 to generate a signal feature vector of the dimension number N.

### (Step S416)

The dimension adjusting unit 345 converts the signal feature vector of the dimension number N generated in step S415 into a text embedding vector of the dimension number P.

### (Step S417)

The language decoding unit 355 uses the text embedding vector of the dimension number P originated from the signal linear projection unit 344 generated in step S416 as an input, and generates a variable length text in which the phonemes of the onomatopoeia are sub-worded, similarly to the sub-worded explanatory sentence 343.

### (Step S418)

The language encoding unit 333 calculates a language feature vector from the sub-worded explanatory sentence 343 generated in step S404 based on the learning parameter of the language encoding unit 333.

### (Step S419)

The language linear projection unit 334 linearly projects the language feature vector generated in step S418 to generate a language feature vector of the dimension number M.

(Step S420) The dimension adjusting unit 345 converts the language feature vector of the dimension number M generated in step S419 into a text embedding vector of the dimension number P.

### (Step S421)

The updating unit 356 performs contrast learning based on the text embedding vector of the dimension number P originated from the signal linear projection unit 344 and generated in step S415 and the text embedding vector of the dimension number P originated from the language linear projection unit 334 and generated in step S419, and updates the learning parameter of each neural network in the signal encoding units 351 and 352, the language encoding unit 333, the signal linear projection unit 344, and the language linear projection unit 334 such that the symmetric loss matrix of the text embedding vectors is small.

Furthermore, the updating unit 356 compares the variable length text (however, in the variable length text, phonemes of the onomatopoeia are sub-worded similarly to the sub-worded explanatory sentence 343) generated in step S417 with the sub-worded explanatory sentence 343 generated in step S404, and updates the learning parameter of each neural network model of the language decoding unit 355 and the dimension adjusting unit 345 such that the cross entropy L of the above formula (1) is minimized.

### (Step S422)

The updating unit 356 calculates a convergence condition.

### (Step S423)

The updating unit 356 increments the number of iterations C1. Then, the processing returns to step S401.

### (Step S424)

Step S401: If Yes, the updating unit 356 stores the learning parameter updated in step S420 in the storage device 102 as the learning parameter of the generative model 203. The learning processing of the learning unit 202 thus ends.

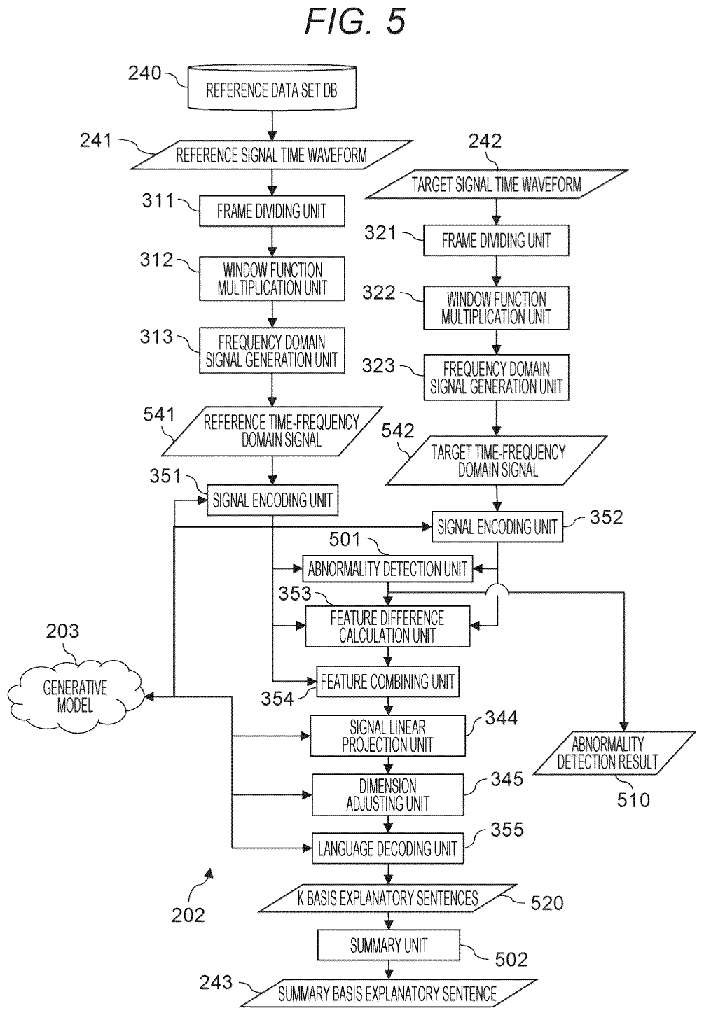

### <FIG. 5 Functional Configuration Example of Generation Unit 204>

FIG. 5 is a block diagram illustrating a functional configuration example of the generation unit 204 according to the first embodiment. The generation unit 204 includes the frame dividing units 311 and 312, the window function multiplication units 321 and 322, the frequency domain signal generation units 313 and 323, the signal encoding units 351 and 352, the feature difference calculation unit 353, the feature combining unit 354, the signal linear projection unit 344, the dimension adjusting unit 345, and the language decoding unit 355. That is, a part of the configuration of the learning unit 202 also functions as the generation unit 204. In addition, the generation unit 204 includes an abnormality detection unit 501 and a summary unit 502.

The abnormality detection unit 501 detects a statistical outlier based on the feature vector from the signal encoding unit 351 and the feature vector from the signal encoding unit 352, and outputs an abnormality detection result 510. Specifically, for example, the abnormality detection unit 501 calculates an average value of K distances (average distance) between the nearest K feature vectors from the signal encoding unit 351 and the feature vectors from the signal encoding unit 352 using the K-nearest neighbor algorithm. The abnormality detection unit 501 determines that the state is abnormal in a case where the average distance is equal to or more than the threshold, and determines that the state is normal when the average distance is less than the threshold.

The language decoding unit 355 uses a text embedding vector of a dimension number P for the reference signal as an input, and generates the nearest K basis explanatory sentences 520 that are variable length texts in which the phonemes of the onomatopoeia are converted to sub-words, similarly to the sub-worded explanatory sentence 343 to be described below.

The summary unit 502 generates a prompt for requesting generation of the summary basis explanatory sentence 243 of the K basis explanatory sentences 520 generated by the language decoding unit 355, and outputs the generated prompt to generative artificial intelligence (AI) (not illustrated). The generative AI may be implemented inside the generation device 100 or may be implemented on an external computer communicable with the generation device 100. The summary unit 502 acquires the summary basis explanatory sentence 243 from the generative AI. The acquired summary basis explanatory sentence 243 is displayed on a display, for example.

Note that the generative AI includes a language model trained by natural language processing using data set, and generates sentences using the language model. Furthermore, the language model is a type of a probability model used in natural language processing, and is a model for probabilistically predicting how a given word or sentence is likely to appear as a natural language. Specifically, the language model is a mathematical model for learning a language pattern, a grammatical rule, and the like in the field of natural language processing, and generating and understanding a natural language.

For example, the generative AI calculates the appearance probability of a given word string or sentence or compares the appearance probabilities of a plurality of word strings or sentences using the language model, thereby automatically generating the most likely word or sentence based on the context when predicting the next word or sentence. As described above, when accepting an inquiry referred to as a prompt, the generative AI outputs an answer to the inquiry using the language model that has learned an enormous amount of data sets.

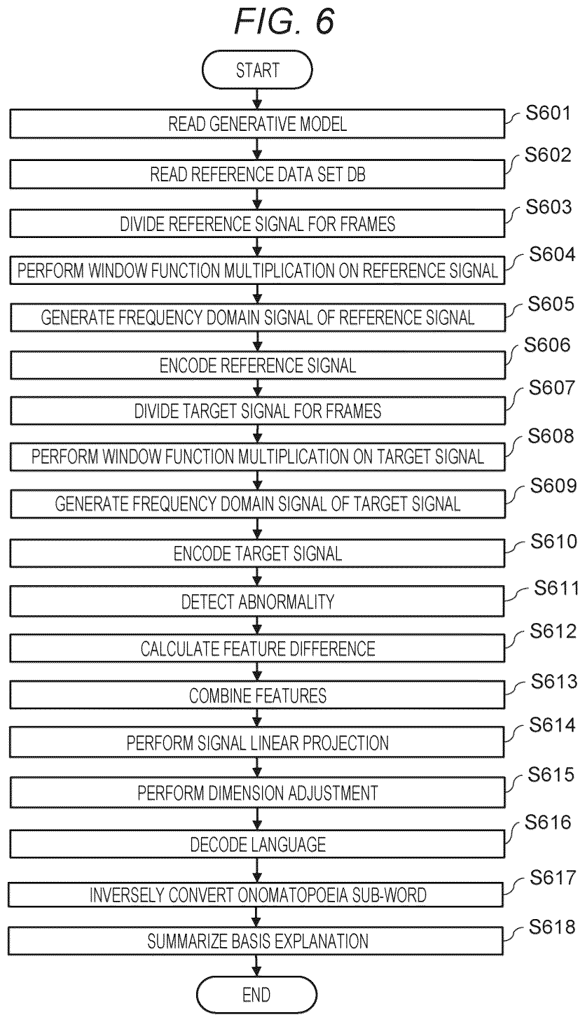

### <FIG. 6 Generation Processing Procedure of Generation Unit 204>

FIG. 6 is a flowchart illustrating an example of a generation processing procedure of the generation unit 204 according to the first embodiment.

### (Step S601)

The generation unit 204 reads the generative model 203.

### (Step S602)

The generation unit 204 reads the reference signal from a reference data set DB 240 to be input as the reference signal time waveform 241.

### (Steps S603 to S605)

The generation unit 204 performs the same processing as that in steps S405 to S407 on the input reference signal time waveform 241. As a result, a frequency domain signal (reference time-frequency domain signal) of the reference signal is generated. When there is a plurality of reference signals, a reference time-frequency domain signal is generated for each reference signal.

### (Step S606)

The signal encoding unit 351 calculates a reference feature vector based on the reference time-frequency domain signal from step S605 using the generative model 203. When there is a plurality of reference time-frequency domain signals, a reference feature vector is generated for each reference time-frequency domain signal.

### (Steps S607 to S609)

The generation unit 204 performs the same processing as that in steps S409 to S411 on the input target signal time waveform 242. As a result, a frequency domain signal (target time-frequency domain signal) of the target signal is generated.

### (Step S610)

The signal encoding unit 352 calculates a target feature vector based on the target time-frequency domain signal from step S609 using the generative model 203.

### (Step S611)

The abnormality detection unit 501 detects a statistical outlier based on the feature vector from the signal encoding unit 351 generated in step S606 and the feature vector from the signal encoding unit 352 generated in step S610, and outputs the abnormality detection result 510.

### (Step S612)

The feature difference calculation unit 353 calculates a difference vector that is a difference between the reference feature vector generated in step S606 and the target feature vector generated in step S610. The difference vector is a feature in which a change is emphasized, and an explanatory sentence in which a change is emphasized can be generated by performing inference using the feature. When there are nearest K reference feature vectors, the difference vector is generated for each reference feature vector.

### (Step S613)

The feature combining unit 354 combines the reference feature vector, the target feature vector, and the difference vector to generate a combined vector. When there are nearest K reference feature vectors, the combined vector is generated for each reference feature vector.

### (Step S614)

The signal linear projection unit 344 linearly projects the combined vector generated in step S613 to generate a signal feature vector of the dimension number N. When there are nearest K combined vectors, the signal feature vector of the dimension number N is generated for each combined vector.

### (Step S615)

The dimension adjusting unit 345 converts the signal feature vector of the dimension number N generated in step S614 into a text embedding vector of the dimension number P. When there are nearest K signal feature vectors of the dimension number N, the text embedding vector of the dimension number P is generated for each signal feature vector of the dimension number N.

### (Step S616)

The language decoding unit 355 uses the text embedding vector of the dimension number P generated in step S615 as input, and generates the variable length text including an onomatopoeia sub-word sequence, using the generative model 203. When there are nearest K text embedding vectors of the dimension number P, the variable length text is generated for each text embedding vector of the dimension number P.

### (Step S617)

The language decoding unit 355 inversely converts the onomatopoeia sub-word sequence in the variable length text generated in step S616 into an onomatopoeia text via the phoneme string of the onomatopoeia. When there are the nearest K variable length texts, the onomatopoeia text is generated for each variable length text.

Here, a method of inversely converting an onomatopoeia sub-word sequence of a text having a variable length into a phoneme string of an onomatopoeia will be described. In the onomatopoeia phoneme conversion (step S403) at the time of learning, when the phoneme string of the onomatopoeia is converted into an onomatopoeia sub-word sequence, the onomatopoeia sub-wording unit 332 creates the onomatopoeia sub-word sequence by shifting the range by one character while overlapping the range for n−1 characters.

Therefore, in the inverse conversion for an onomatopoeia sub-word sequence S=[s_1, . . . , s_M] including M onomatopoeia sub-words s_m (m=1, . . . , M), the language decoding unit 355 extracts, for the phoneme m=1, . . . , M−1, only v_m1, which is the first character of the m-th sub-word s_m=[v_m1, . . . , v_mn], as follows.

For the last sub-word s_M where m=M, the language decoding unit 355 extracts the entire character string s_M=[v_M1, . . . , v_Mn]. That is, [v_11, v_21, v_31, . . . , v_{M−1} 1, v_M1, . . . , v_Mn] is generated as a phoneme string of the onomatopoeia.

Next, in the inverse conversion of the phoneme string of the onomatopoeia into the onomatopoeia text, since there is a one-to-one relationship between phonemes and Katakana characters, the language decoding unit 355 may perform conversion according to the correspondence table. As a result, the onomatopoeia text is restored.

### (Step S618)

The summary unit 502 generates a prompt for requesting generation of the summary basis explanatory sentence 243 of the nearest K basis explanatory sentences 520 generated in step S617, outputs the prompt to the generative AI, and acquires the summary basis explanatory sentence 243 from the generative AI. The acquired summary basis explanatory sentence 243 is displayed on a display, for example. The generation processing of the generation unit 204 thus ends.

By using the same feature space for the sound and the language as described above, appropriate language explanation from the same viewpoint can be made as a basis for abnormality detection.

Note that, in the above-described configuration, the generation device 100 may be configured without the signal linear projection unit 344, the language linear projection unit 334, or the dimension adjusting unit 345. Even in a case where the signal linear projection unit 344, the language linear projection unit 334, or the dimension adjusting unit 345 is not used, the dimension number of the combined vector output from the feature combining unit 354 and the dimension number of the language feature vector output from the language encoding unit 333 are set to be the same dimension number to enable contrast learning.

### Second Embodiment

A second embodiment will be described. In the second embodiment, the feature combining unit 354 is excluded from the configuration in the first embodiment. In the second embodiment, differences from the first embodiment will be mainly described, and description of common parts with the first embodiment will be omitted.

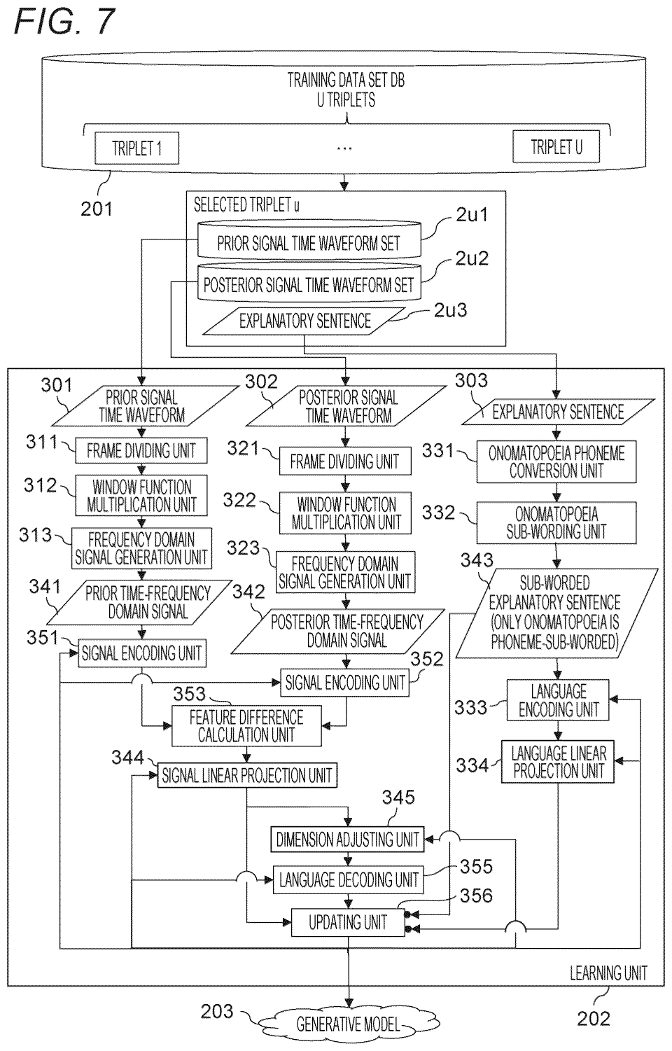

### <FIG. 7 Functional Configuration Example of Learning Unit 202>

FIG. 7 is a block diagram illustrating a functional configuration example of a learning unit 202 according to the second embodiment. Since the feature combining unit 354 does not exist, the signal linear projection unit 344 is a neural network that linearly projects the difference vector from the feature difference calculation unit 353 to generate a signal feature vector of the dimension number N. This neural network is, for example, a fully connected layer or a combination of a fully connected layer and a suitable activation nonlinear function such as ReLU.

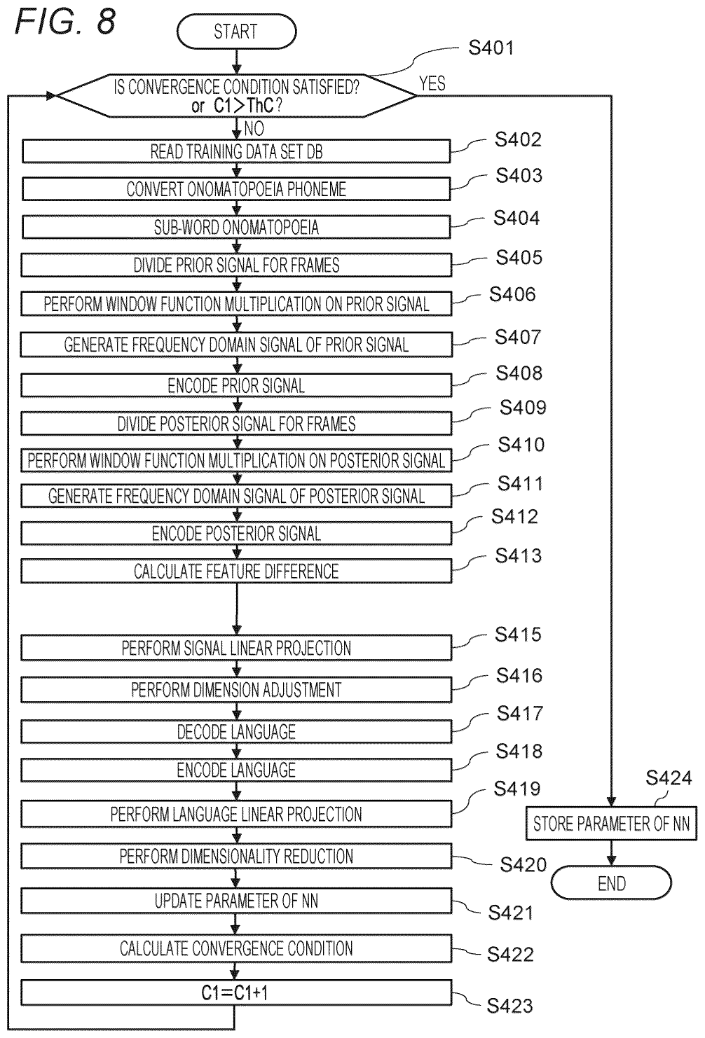

### <FIG. 8 Learning Processing Procedure of Learning Unit 202>

FIG. 8 is a flowchart illustrating an example of a learning processing procedure of the learning unit 202 according to the second embodiment. In the second embodiment, step S414 is not performed.

### (Step S415)

The signal linear projection unit 344 linearly projects the difference vector generated in step S413 to generate a signal feature vector of the dimension number N.

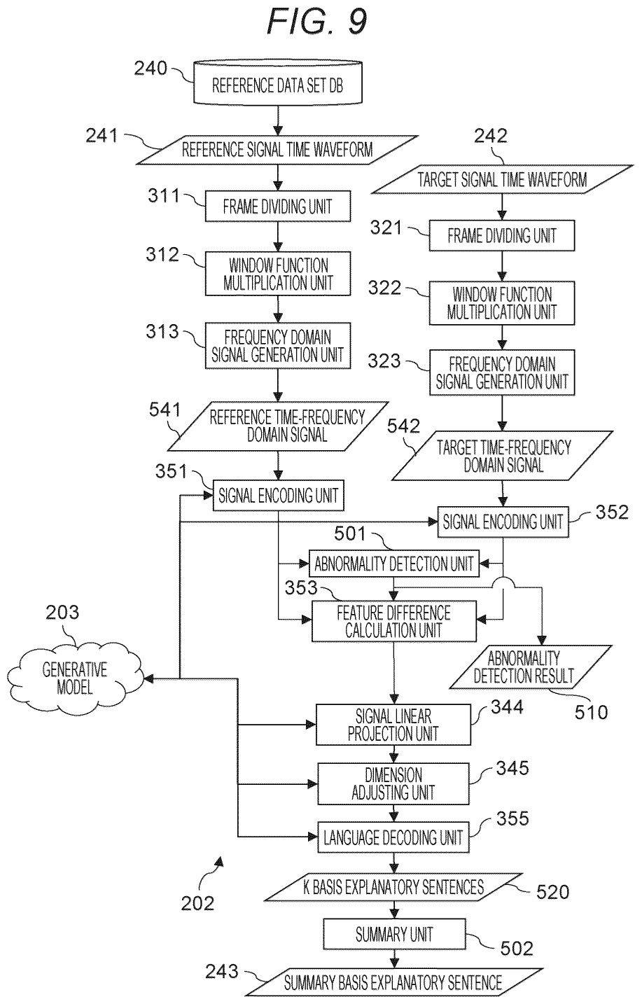

### <FIG. 9 Functional Configuration Example of Generation Unit 204>

FIG. 9 is a block diagram illustrating a functional configuration example of a generation unit 204 according to the second embodiment. Since the feature combining unit 354 does not exist, the signal linear projection unit 344 is a neural network that linearly projects the difference vector from the feature difference calculation unit 353 to generate a signal feature vector of the dimension number N. This neural network is, for example, a fully connected layer or a combination of a fully connected layer and a suitable activation nonlinear function such as ReLU.

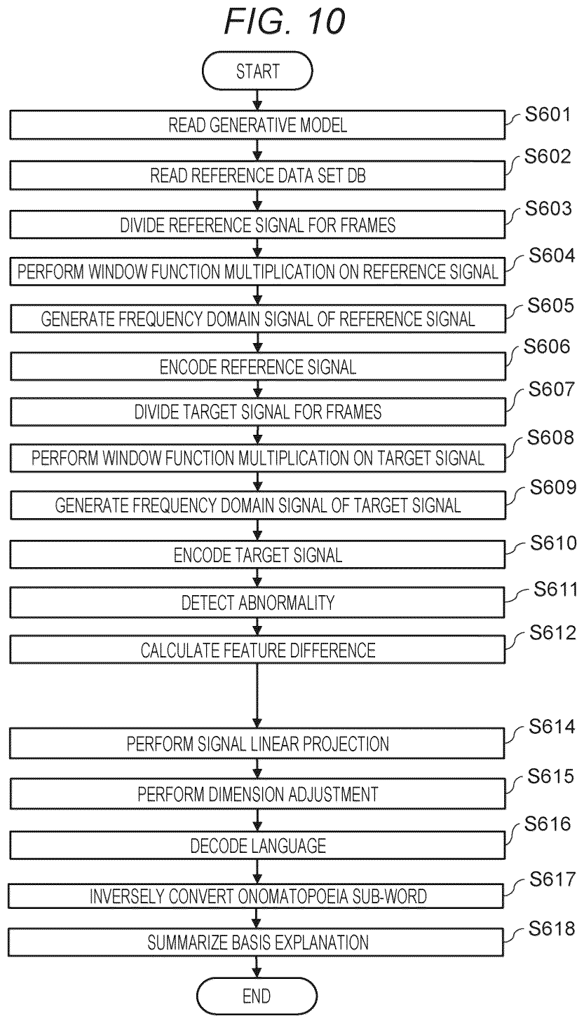

### <FIG. 10 Generation Processing Procedure of Generation Unit 204>

FIG. 10 is a flowchart illustrating an example of a generation processing procedure of the generation unit 204 according to the second embodiment. In the second embodiment, step S616 is not performed.

### (Step S614)

The signal linear projection unit 344 linearly projects the difference vector generated in step S612 to generate a signal feature vector of the dimension number N. When there are nearest K combined vectors, the signal feature vector of the dimension number N is generated for each difference vector.

According to the second embodiment, since the feature combining unit 354 is not used, the signal linear projection unit 344 performs linear projection using a difference vector of the dimension number smaller than that of the combined vector. Therefore, the processing speed of the signal linear projection unit 344 is increased.

### Third Embodiment

A third embodiment will be described. In the third embodiment, the feature difference calculation unit 353 and the feature combining unit 354 are excluded from the configuration in the first embodiment. In the third embodiment, differences from the first embodiment and the second embodiment will be mainly described, and description of common parts with the first embodiment and with the second embodiment will be omitted.

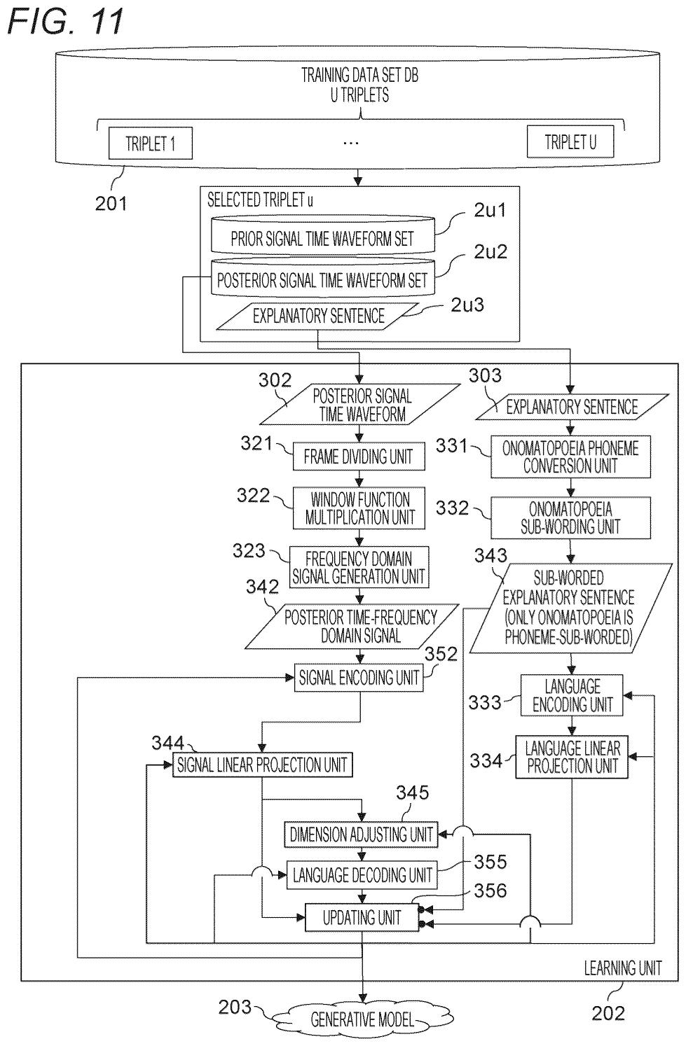

### <FIG. 11 Functional Configuration Example of Learning Unit 202>

FIG. 11 is a block diagram illustrating a functional configuration example of a learning unit 202 according to the third embodiment. Since the difference calculation and the combination of the feature vectors are not performed, the learning unit 202 acquires the posterior signal time waveform 302, and performs frame division, window function multiplication, frequency domain signal generation, and signal encoding.

Further, the explanatory sentence 2u3 is a variable length text including an onomatopoeia representing a change between the prior signal time waveform and the posterior signal time waveform. However, in the case of the third embodiment, the explanatory sentence 2u3 is a variable length text including an onomatopoeia representing the acquired posterior signal time waveform.

The signal linear projection unit 344 is a neural network that linearly projects the feature vector from the posterior signal encoding unit 352 to generate a signal feature vector of the dimension number N. This neural network is, for example, a fully connected layer or a combination of a fully connected layer and a suitable activation nonlinear function such as ReLU.

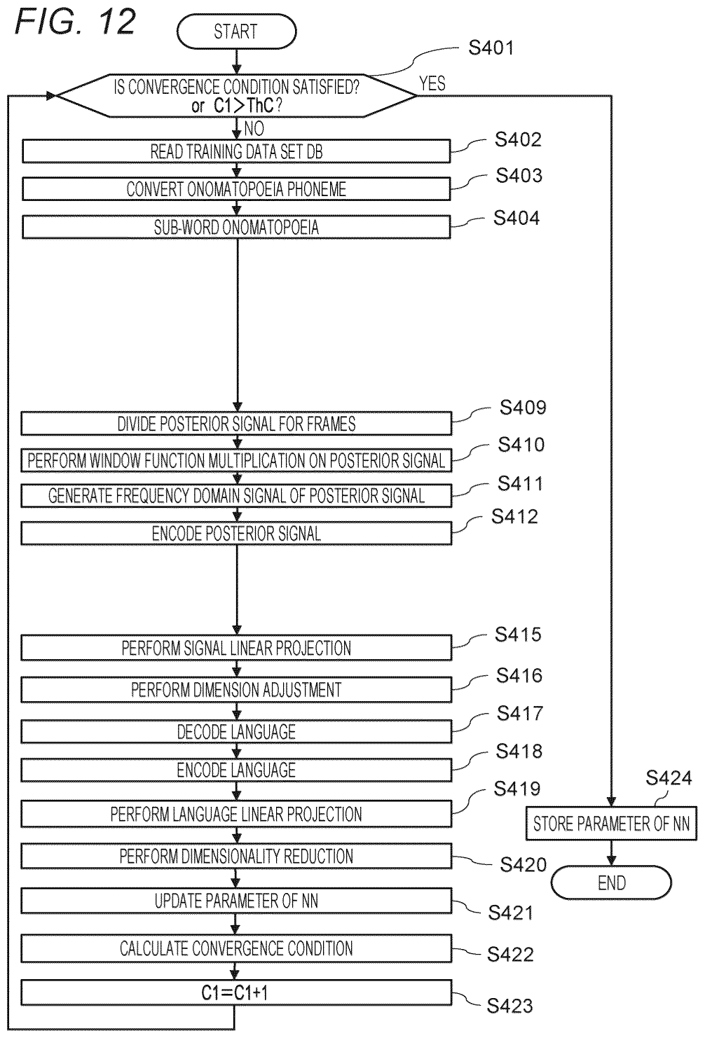

### <FIG. 12 Learning Processing Procedure of Learning Unit 202>

FIG. 12 is a flowchart illustrating an example of a learning processing procedure of the learning unit 202 according to the third embodiment. In the third embodiment, step S413 or step S414 is not performed.

### (Step S415)

The signal linear projection unit 344 linearly projects the feature vector generated in step S418 or step S412 to generate a signal feature vector of the dimension number N.

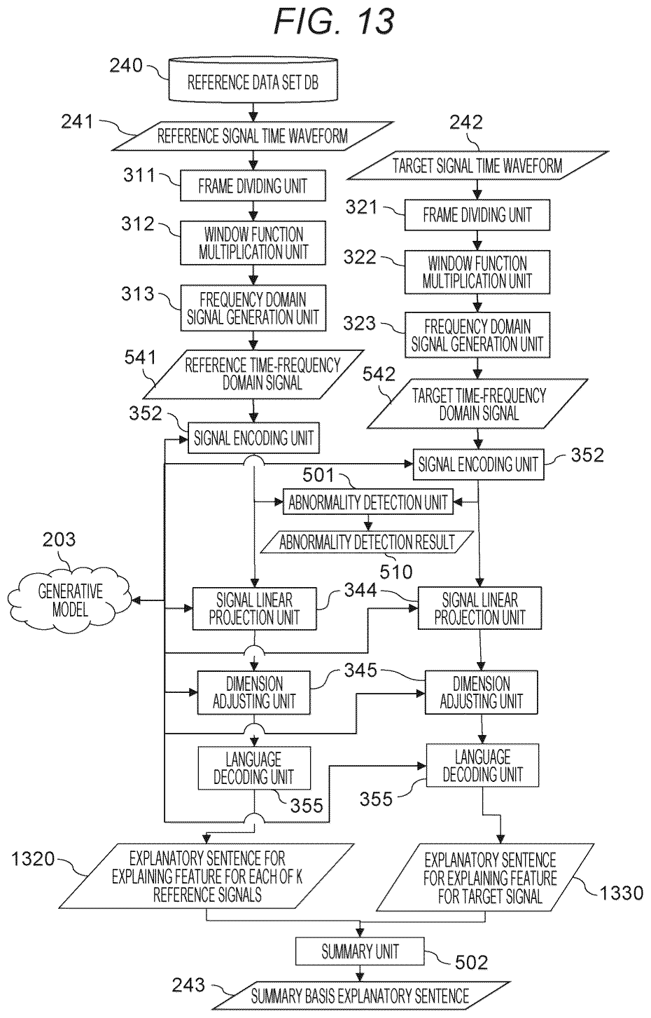

### <FIG. 13 Functional Configuration Example of Generation Unit 204>

FIG. 13 is a block diagram illustrating a functional configuration example of the generation unit 204 according to the third embodiment. Since the feature difference calculation unit 353 and the feature combining unit 354 do not exist, the signal linear projection unit 344 linearly projects the feature vector for the reference signal from the signal encoding unit 352 to generate nearest K signal feature vectors for the reference signal of the dimension number N. In addition, the signal linear projection unit 344 linearly projects the feature vector for the target signal from the signal encoding unit 352 to generate a signal feature vector for the target signal of the dimension number M.

The dimension adjusting unit 345 converts the signal feature vector for the reference signal of the dimension number N from the signal linear projection unit 344 into a text embedding vector of the dimension number P. In addition, the dimension adjusting unit 345 converts the signal feature vector for the target signal of the dimension number M from the signal linear projection unit 344 into a text embedding vector of the dimension number P.

The language decoding unit 355 uses a text embedding vector of the dimension number P for the reference signals as an input, and generates an explanatory sentence 1320 for explaining a feature for each of K reference signals that are variable length texts in which phonemes of an onomatopoeia are sub-worded similarly to the sub-worded explanatory sentence 343 to be described below.

The language decoding unit 355 uses a text embedding vector of the dimension number P for the target signal as an input, and generates an explanatory sentence 1330 for explaining a feature for the target signal that is a variable length text in which phonemes of an onomatopoeia are sub-worded similarly to the sub-worded explanatory sentence 343 to be described below.

The summary unit 502 generates a prompt for requesting generation of the summary basis explanatory sentence 243 of the explanatory sentence 1320 and the explanatory sentence 1330 generated by the language decoding unit 355, and outputs the generated prompt to generative AI (not illustrated). The summary unit 502 generates, for example, the following prompt.

“The explanatory sentences expressing the feature of signals in the normal state are as follows.
1st: . . . (explanatory sentence of the first reference signal is inserted)
2nd: . . . (explanatory sentence of the second reference signal is inserted) . . .
. . .
K-th: . . . (explanatory sentence of the K-th reference signal is inserted)

With respect to the signals, the feature of the signals changed as in the following explanatory sentence, resulting in detection of an abnormality . . .
. . . (explanatory sentence 1330 of the target signal is inserted)

Please explain the change in the feature of the signals compared to those in the normal state as a basis of detection of the abnormality.”

The summary unit 502 acquires the summary basis explanatory sentence 243 from the generative AI. The acquired summary basis explanatory sentence 243 is displayed on a display, for example.

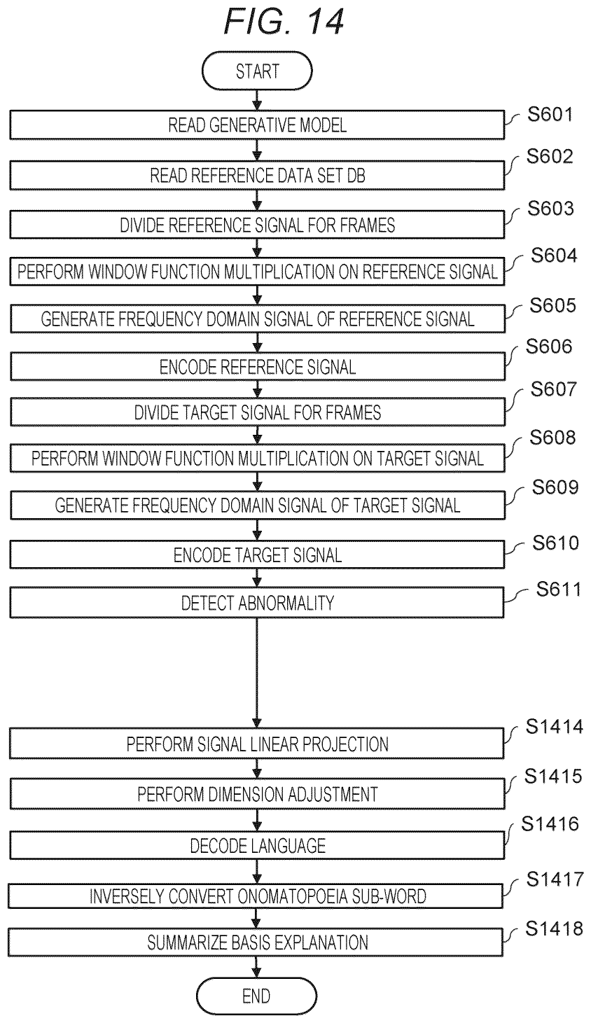

### <FIG. 14 Generation Processing Procedure of Generation Unit 204>

FIG. 14 is a flowchart illustrating an example of a generation processing procedure of the generation unit 204 according to the third embodiment. In the third embodiment, step S616 is not performed.

### (Step S1414)

After step S611, the signal linear projection unit 344 linearly projects the feature vectors generated in step S606 to generate signal feature vectors of the dimension number N. The signal feature vectors of the dimension number N for the nearest K reference signals among the feature vectors generated in step S606 are generated.

In addition, the signal linear projection unit 344 linearly projects the feature vectors generated in step S610 to generate signal feature vectors of the dimension number M for the target signal.

### (Step S1415)

The dimension adjusting unit 345 converts the signal feature vectors of the dimension number N for the reference signals generated in step S1414 into text embedding vectors of the dimension number P. When there are nearest K signal feature vectors of the dimension number N, the text embedding vector of the dimension number P is generated for each signal feature vector of the dimension number N.

In addition, the dimension adjusting unit 345 converts the signal feature vectors of the dimension number M for the target signal generated in step S1414 into text embedding vectors of the dimension number P.

### (Step S1416)

The language decoding unit 355 uses the text embedding vectors of the dimension number P generated in step S1415 as input, and generates the variable length texts including an onomatopoeia sub-word sequence, using the generative model 203. When there are nearest K text embedding vectors of the dimension number P, the variable length text is generated for each text embedding vector of the dimension number P. Furthermore, a variable length text is also generated for a text embedding vector of the dimension number P for the target signal.

### (Step S1417)

The language decoding unit 355 inversely converts the onomatopoeia sub-word sequence in the variable length text generated in step S1416 into an onomatopoeia text via the phoneme string of the onomatopoeia. When there are nearest K variable length texts for the reference signals, each variable length text for the reference signal is inversely converted into an onomatopoeia text. The onomatopoeia texts are K explanatory sentences 1320. Further, the variable length text for the target signal is also inversely converted into an onomatopoeia text. This onomatopoeia text is the explanatory sentence 1330 for the target signal.

### (Step S1418)

The summary unit 502 generates a prompt for requesting generation of the summary basis explanatory sentence 243 of the nearest K basis explanatory sentences 1320 and explanatory sentence 1330 generated in step S1417, outputs the prompt to the generative AI, and acquires the summary basis explanatory sentence 243 from the generative AI. The acquired summary basis explanatory sentence 243 is displayed on a display, for example. The generation processing of the generation unit 204 thus ends.

According to the third embodiment, since the feature difference calculation unit 353 is not used, learning can be performed only with a text expressing a feature of a single signal. Therefore, in a case where a text expressing the feature of a single signal can be collected more easily than a text expressing the difference between signals, the processing can be performed at lower cost.

In addition, since the feature combining unit 354 is not used, the signal linear projection unit 344 performs linear projection using a difference vector of the dimension number smaller than that of the combined vector. Therefore, the processing speed of the signal linear projection unit 344 is increased.

### <Model Switching for Each Type of Signal to be Focused On>

The signals observed as the prior signal and the posterior signal are roughly classified into three types, a steady signal, a periodic signal, and an aperiodic signal, for example. The type of model suitable as the model (hereinafter, an encoding model) of the signal encoding units 351 and 352 differs depending on the type of signal. For example, a network with a spatial attention mechanism is suitable for the steady signal, and is more accurate than Transformer.

For periodic and aperiodic signals, Transformer is suitable and more accurate than a network with a spatial attention mechanism. In addition, it is more accurate to prepare different encoding models for the types, the steady signal, the periodic signal, and the aperiodic signal. Therefore, the generation device 100 constructs these three types of encoding models as the generative models 203 as follows. As a premise, the training data set DB 201 is prepared for each type of signal.

The training data set DB 201 for a steady signal includes the prior signal time waveform set 211 of a steady signal, the posterior signal time waveform set 212 of a steady signal, and an explanatory sentence set 213 that includes explanations of the change therebetween by an annotator. Further, by instructing the annotator to explain the change “focusing on a steady signal”, the training data set DB 201 specialized for a steady signal can be constructed. Then, by preparing, as the encoding model, a network including a spatial attention mechanism suitable for a steady signal as described above, the learning unit 202 performs learning of the generative model 203.

The training data set DB 201 for a periodic signal includes the prior signal time waveform set 211 of a periodic signal, the posterior signal time waveform set 212 of a periodic signal, and an explanatory sentence set 213 that includes explanations of the change therebetween by an annotator. Further, by instructing the annotator to explain the change “focusing on a periodic signal”, the training data set DB 201 specialized for a periodic signal can be constructed. Then, by preparing, as the encoding model, Transformer suitable for a periodic signal as described above, the learning unit 202 performs learning of the generative model 203.

The training data set DB 201 for an aperiodic signal includes the prior signal time waveform set of an aperiodic signal, the posterior signal time waveform set of an aperiodic signal, and an explanatory sentence set 213 that includes explanations of the change therebetween by an annotator. Further, by instructing the annotator to explain the change “focusing on an aperiodic signal”, the training data set DB 201 specialized for an aperiodic signal can be constructed. Then, by preparing, as the encoding model, Transformer suitable for an aperiodic signal as described above, the learning unit 202 performs learning of the generative model 203.

The generation unit 204 uses the above three types of generative models 203 while switching therebetween. For example, in a use scene in which it is known that a specific type of signal is to be focused on, the generation unit 204 specifies and implements the generative model 203 of the type, so that the summary basis explanatory sentence 243 can be generated with high accuracy specialized for the specified type of signal and without being adversely affected by other noises.

The generation unit 204 may simultaneously use the three types of generative models 203 in parallel. For example, the character string “For a steady signal,” can be added to the beginning of the summary basis explanatory sentence 243 output from the generative model 203 for a steady signal, the character string “For a periodic signal,” can be added to the beginning of the summary basis explanatory sentence 243 output from the generative model 203 for a periodic signal, the character string “For an aperiodic signal,” can be added to the beginning of the summary basis explanatory sentence 243 output from the generative model 203 for an aperiodic signal, and these three explanatory sentences can be connected while distinguishing them and output. As a result, a user can read the explanation from a plurality of viewpoints corresponding to the three types of generative models 203 at the same time, providing an effect that the user can compare the explanations between the viewpoints easily and can gain awareness easily.

Note that, here, as an example, it has been described that the generation unit 204 implements the three types of generative models 203 in parallel, but the generation unit 204 may implement two types of generative models 203 out of the three types of generative models 203 in parallel. In addition, if there are signals other than the above-described three types, the generation unit 204 may implement four or more types of the generative models 203 in parallel.

As described above, two conditions are defined as A and B, a character string C for explaining the difference between a set S_A including one or more sample signals corresponding to the condition A (for example, in a normal state (prior signal)) and a set S_B including one or more sample signals corresponding to the condition B (for example, in an abnormal state (posterior signal)) is added by an annotator, and the set of triplets including the set S_A, the set S_B, and the character string C is set as a training data set.

At the time of learning, the generation device 100 performs learning of the generative model 203 to make it output the character string C using each element of the set S_A and the set S_B as an input. At the time of inference, the generation device 100 generates an inference explanatory sentence 234 from the signals of the condition A and the condition B using the generative model 203.

An annotator who does not know what to focus on among the myriad of changes tends to compare samples of the signal on a one-to-one basis and explain outliers rather than significant changes. On the other hand, in the present embodiment, even in a case where an annotator does not have expertise, it is possible to find a significant change between the condition A and the condition B regardless of the outlier and provide the character string C by comparing samples of a plurality of different pairs of the samples of the different conditions.

Therefore, for example, the learning unit 202 repeatedly selects a combination of the prior signal time waveform and the posterior signal time waveform from the triplet u selected as the training data set created in this way, and performs learning of the generative model 203 using the combined vector and the explanatory sentence 2u3 repeatedly generated for the selected combination. As a result, the generation unit 204 can generate the inference explanatory sentence 234 focusing on a significant change due to changes between the condition A and the condition B at the time of inference using the generative model 203.

As described above, even if an annotator does not know in advance what should be focused on among the myriad of changes, the generation device 100 described above can learn to explain in natural language or infer what has changed between the signals due to the change in the condition from signals obtained under the two different conditions as described. Thus, an annotator can easily identify what should be focused on among the myriad of changes.

Note that, in the above-described embodiments, the generation device 100 includes the learning unit 202 and the generation unit 204, but may include one of the learning unit 202 and the generation unit 204, and the other may be included in another computer that can communicate with the generation device 100.

Furthermore, in the above-described embodiments, the sound signal has been described as an example, but even for a signal of an ultrasonic sensor, the present invention can be realized similarly. In addition, the present invention can be implemented with the same configuration for general time-series signals such as a time waveform of an acceleration sensor or a displacement sensor, a time waveform of a current sensor, and a financial index such as a stock price or an exchange rate. In the case of a time waveform of a current sensor, a financial index such as a stock price or an exchange rate, or the like, an “onomatopoeia” that does not express a sound can be processed by the onomatopoeia phoneme conversion unit 331 and the onomatopoeia sub-wording unit 332.

Note that the present invention is not limited to the above-described embodiments, and includes various modifications and equivalent configurations within the spirit of the appended claims. For example, the above-described embodiments have been provided in detail for easy understanding of the present invention, and the present invention is not limited to those having all the described components. In addition, a part of the components of a certain embodiment may be replaced with a component of another embodiment. In addition, to the components of a certain embodiment, a component of another embodiment may be added. In addition, a component of another embodiment may be added to each embodiment, and a part of the components may be deleted, or replaced.

In addition, a part or all of the above-described components, functions, processing units, processing means, and the like may be realized by hardware by, for example, designing an integrated circuit, or may be realized by software by a processor interpreting and executing a program for realizing each function.

Information such as a program, a table, and a file for realizing each function can be stored in a storage device such as a memory, a hard disk, and a solid state drive (SSD), or a recording medium such as an integrated circuit (IC) card, an SD card, and a digital versatile disc (DVD).

In addition, only the control lines and the information lines that are considered to be necessary for the description are indicated, and all the control lines and the information lines that are necessary for implementation are not necessarily described. In practice, it may be considered that almost all the components are connected to each other.

1. A generation device comprising:
a storage unit that stores a set of training data sets each being a combination of a sound signal indicating a state and an explanatory sentence explaining the state in a character string;
a signal encoding unit configured to encode, based on a first learning parameter, the sound signal to generate a sound feature vector;
a language encoding unit configured to encode, based on a second learning parameter, the explanatory sentence to generate a language feature vector;
a language decoding unit configured to decode, based on a third learning parameter, the sound feature vector into a text indicating the state; and
an updating unit configured to update the first learning parameter and the second learning parameter by contrast learning using a combination of a sound feature vector generated by the signal encoding unit and a language feature vector generated by the language encoding unit, and updates the third learning parameter based on a difference between the explanatory sentence and the text indicating the state decoded by the language decoding unit.

2. The generation device according to claim 1, wherein
the storage unit stores, as the sound signal, a prior signal indicating the state before a change and a posterior signal indicating the state after the change, and the explanatory sentence is a sentence explaining the states before and after the change in a character string,
the signal encoding unit includes a first signal encoding unit and a second signal encoding unit,
the first signal encoding unit encodes, based on a fourth learning parameter, the prior signal to generate a prior sound feature vector,
the second signal encoding unit encodes, based on a fifth learning parameter, the posterior signal to generate a posterior sound feature vector,
the language decoding unit decodes, based on the third learning parameter, a first difference vector between the prior sound feature vector and the posterior sound feature vector into a text indicating the state, and
the updating unit updates the fourth learning parameter, the fifth learning parameter, and the second learning parameter by contrast learning using a combination of the first difference vector and the language feature vector, and updates the third learning parameter based on a difference between the text indicating the state and the explanatory sentence.

3. The generation device according to claim 2, wherein
the language decoding unit decodes a first combined vector obtained by combining the prior sound feature vector, the posterior sound feature vector, and the first difference vector into a text indicating the state based on the third learning parameter, and
the updating unit updates the fourth learning parameter, the fifth learning parameter, and the second learning parameter by contrast learning using a combination of the first combined vector and the language feature vector, and updates the third learning parameter based on a difference between the text indicating the state and the explanatory sentence.

4. The generation device according to claim 1, further comprising
an abnormality detection unit configured to detect an abnormality of an abnormality detection target, wherein
the signal encoding unit encodes, based on the first learning parameter, a reference sound signal as a reference in a case where the state of the abnormality detection target is normal to generate a reference sound feature vector, and encodes, based on the first learning parameter, a target signal emitted by the abnormality detection target to generate a target sound feature vector, and
the abnormality detection unit detects an abnormality of the abnormality detection target based on the reference sound feature vector and the target sound feature vector.

5. The generation device according to claim 4, further comprising
a summary unit configured to generate a summary sentence indicating a basis of abnormality detection by the abnormality detection unit, wherein
the language decoding unit decodes, based on the third learning parameter, the reference sound feature vector based on an abnormality detection result by the abnormality detection unit into a first basis explanatory sentence indicating a basis of the abnormality detection, and decodes, based on the third learning parameter, the target sound feature vector into a second basis explanatory sentence indicating a basis of the abnormality detection, and
the summary unit generates the summary sentence based on the first basis explanatory sentence and the second basis explanatory sentence.

6. The generation device according to claim 2, further comprising
an abnormality detection unit configured to detect an abnormality of an abnormality detection target, wherein
the first signal encoding unit encodes, based on the fourth learning parameter, a reference sound signal as a reference in a case where the state of the abnormality detection target is normal to generate a reference sound feature vector,
the second signal encoding unit encodes, based on the fifth learning parameter, a target signal emitted by the abnormality detection target to generate a target sound feature vector, and
the abnormality detection unit detects an abnormality of the abnormality detection target based on a second difference vector between the reference sound feature vector and the target sound feature vector.

7. The generation device according to claim 6, further comprising
a summary unit configured to generate a summary sentence indicating a basis of abnormality detection by the abnormality detection unit, wherein
the language decoding unit decodes, based on the third learning parameter, the second difference vector based on an abnormality detection result by the abnormality detection unit into a first basis explanatory sentence indicating a basis of the abnormality detection, and
the summary unit generates the summary sentence based on the first basis explanatory sentence.

8. The generation device according to claim 3, further comprising
an abnormality detection unit configured to detect an abnormality of an abnormality detection target, wherein
the first signal encoding unit encodes, based on the fourth learning parameter, a reference sound signal as a reference in a case where the state of the abnormality detection target is normal to generate a reference sound feature vector,
the second signal encoding unit encodes, based on the fifth learning parameter, a target signal emitted by the abnormality detection target to generate a target sound feature vector, and
the abnormality detection unit detects an abnormality of the abnormality detection target based on a second combined vector obtained by combining the reference sound feature vector, the target sound feature vector, and a second difference vector between the reference sound feature vector and the target sound feature vector.

9. The generation device according to claim 8, further comprising
a summary unit configured to generate a summary sentence indicating a basis of abnormality detection by the abnormality detection unit, wherein
the language decoding unit decodes, based on the third learning parameter, the second combined vector based on an abnormality detection result by the abnormality detection unit into a first basis explanatory sentence indicating a basis of the abnormality detection, and
the summary unit generates the summary sentence based on the first basis explanatory sentence.

10. A generation method performed by a generation device that includes a processor that executes instructions stored in a non-transitory computer readable medium and a storage device that comprises the non-transitory computer readable medium storing the instructions and is capable of accessing a set of training data sets each being a combination of a sound signal indicating a state and an explanatory sentence explaining the state in a character string, the processor performing:
signal encoding processing of encoding, based on a first learning parameter, the sound signal to generate a sound feature vector;
language encoding processing of encoding, based on a second learning parameter, the explanatory sentence to generate a language feature vector;
language decoding processing of decoding, based on a third learning parameter, the sound feature vector into a text indicating the state; and
update processing of updating the first learning parameter and the second learning parameter by contrast learning using a combination of a sound feature vector generated by the signal encoding processing and a language feature vector generated by the language encoding processing, and updates the third learning parameter based on a difference between the explanatory sentence and the text indicating the state decoded by the language decoding processing.

11. A non-transitory computer readable medium including instructions associated with a generation device that includes the processor that executes the instructions and a storage device that stores the instructions and is capable of accessing a set of training data sets each being a combination of a sound signal indicating a state and an explanatory sentence explaining the state in a character string, the non-transitory computer readable medium causing the processor to perform:
signal encoding processing of encoding, based on a first learning parameter, the sound signal to generate a sound feature vector;
language encoding processing of encoding, based on a second learning parameter, the explanatory sentence to generate a language feature vector;
language decoding processing of decoding, based on a third learning parameter, the sound feature vector into a text indicating the state; and
update processing of updating the first learning parameter and the second learning parameter by contrast learning using a combination of a sound feature vector generated by the signal encoding processing and a language feature vector generated by the language encoding processing, and updates the third learning parameter based on a difference between the explanatory sentence and the text indicating the state decoded by the language decoding processing.
